(19) United States
(12) Patent Application Publication
(10) Pub. No.: US 2016/0013481 A1
(43) Pub. Date: Jan. 14, 2016

(54) ANODE ACTIVE MATERIAL FOR LITHIUM SECONDARY BATTERY AND METHOD FOR PREPARING SAME

(71) Applicant: OCI COMPANY LTD., Seoul (KR)

(72) Inventors: Eun-Hye JEONG, Seongnam-si (KR); Yo-Seop KIM, Seongnam-si (KR); Sung-Ho JUNG, Seongnam-si (KR); Jeong-Hyun HA, Seongnam-si (KR)

(21) Appl. No.: 14/793,718

(22) Filed: Jul. 7, 2015

(30) Foreign Application Priority Data
Jul. 11, 2014 (KR) 10-2014-0087598

(51) Int. Cl. H01M 4/36; H01M 10/052; H01M 4/62

(52) U.S. Cl. CPC H01M 4/366; H01M 4/625; H01M 4/626; H01M 4/624; H01M 10/052; H01M 2220/20

(57) ABSTRACT

The present invention relates to an anode active material for a lithium secondary battery, which comprises a core layer comprising a carbon-silicon composite, and a shell layer comprising a conductive material and a carbonaceous material for fixing the conductive material, uniformly coated on a surface of the core layer; and the preparation method thereof.

### CROSS REFERENCE TO RELATED APPLICATION

This application claims the benefit of Korean Patent Application No. 10-2014-0087598, filed on Jul. 11, 2014, entitled “ANODE ACTIVE MATERIAL FOR LITHIUM SECONDARY BATTERY AND METHOD FOR PREPARING SAME”, which is hereby incorporated by reference in its entirety into this application.

### TECHNICAL FIELD

The present invention relates to an anode active material for a lithium secondary battery and a method for preparing same.

### BACKGROUND ART

An anode material of a lithium secondary battery capable of implementing high capacity and output is required to be used for a battery for an information technology (IT) equipment or a battery for an automobile. Accordingly, silicon has attracted attention as the anode material of the lithium secondary battery with high capacity. For example, it is known that pure silicon has a high theoretical capacity of 4200 mAh/g.

However, as compared with a carbon-based material, silicon has deteriorated cycle property, which is still an obstacle to practical use. The reason is because when inorganic particles such as silicon, as an anode active material, are directly used as a material for absorption and release of lithium, conductivity between active materials is deteriorated due to a change in volume during a charge and discharge process, or the anode active material is separated from an anode current collector. That is, the inorganic particles such as silicon included in the anode active material absorb lithium by a charge process to expand so as to be about 300% to 400% in volume. In addition, when the lithium is released by a discharge process, the inorganic particles are contracted, and when the charge and discharge cycles are repeated, electrical insulation may occur due to empty space generated between the inorganic particles and the anode active material to cause rapid deterioration in lifespan, and therefore, the inorganic particles have a serious problem in being used for a secondary battery.

Additionally, when silicon is used as an anode active material, the electrical conductivity is low, and the conductivity of the battery decreases. Thereby, the theoretical capacity is not high enough for the battery. Further, when the short circuit between the anode active material and the electrode occurs due to volume expansion, the capacity is rapidly reduced. In order to overcome these problems, a conductive material which can be used to increase the conductivity should be included in the preparation of anode slurry to make electrodes for the secondary battery. In this case, however, further problems are that the dispersibility between the silicon anode active material and the conductive material, and the dust blown-out of the conductive material itself may occur.

### DISCLOSURE

### Technical Problem

Accordingly, in order to further improve the stability of charge and discharge of the secondary battery, the present invention is designed to provide an anode active material for a secondary battery, comprising a core layer comprising a carbon-silicon composite; and a shell layer comprising a conductive material and a carbonaceous material for fixing the conductive material, uniformly coated on a surface of the core layer.

However, objectives of the present invention are not limited to the above-mentioned object, and other objects of the present invention can be clearly understood by those skilled in the art from the following description.

### Technical Solution

In accordance with one aspect of the present invention, there is provided an anode active material for a secondary battery: comprising, a core layer comprising a carbon-silicon composite; and a shell layer comprising a conductive material and a carbonaceous material for fixing the conductive material, uniformly coated on a surface of the core layer.

The core layer may have a mass ratio of Si to C of 1:99 to 10:90.

The core layer may include at least one carbonaceous material selected from the group consisting of natural or artificial graphite, soft carbon, hard carbon, pitch carbide, calcined coke, graphene, carbon nanotube, polymeric carbide and combinations thereof.

The core layer may be in a range of 60% to 99% by weight relative to the anode active material.

The conductive material in the shell layer may include at least one selected from the group consisting of carbon black, acetylene black, Ketjen black, furnace black, carbon fiber, fullerene, copper, nickel, aluminum, silver, cobalt oxide, titanium oxide, polyphenylene derivatives, polythiophene, polyacene, polyacetylene, polypyrrole, polyaniline, and combinations thereof.

The conductive material in the shell layer may be in a range of 1% to 40% by weight relative to the anode active material.

The carbonaceous material for fixing the conductive material in the shell layer may include at least one selected from the group consisting of natural or artificial graphite, soft carbon, hard carbon, pitch carbide, calcined coke, graphene, carbon nanotube, and combinations thereof.

In accordance with another aspect of the present invention, there is provided a method for preparing an anode active material for a secondary battery: comprising, (a) mixing a carbon source with a slurry comprising silicon particles and a first dispersion medium, and then carrying out a first carbonization to form a core layer; and (b) mixing the core layer with a conductive material and a carbonaceous material for fixing the conductive material in a second dispersion medium, and then carrying out a second carbonization to form a shell layer.

In step (a), the carbon source may include at least one selected from the group consisting of natural or artificial graphite, soft carbon, hard carbon, pitch, calcined coke, graphene, carbon nanotube, polymer, and combinations thereof.

In step (a), the silicon particles in the slurry satisfy 2 nm<D50<180 nm, where D50 denotes an average diameter of the silicon particles at 50% of cumulative particle size distribution.

In step (a), the first dispersion medium may include at least one selected from the group consisting of N-methyl-2-pyrrolidone (NMP), tetrahydrofuran (THF), water, ethanol, methanol, cyclohexanol, cyclohexanone, methyl ethyl ketone, acetone, ethylene glycol, octyne, diethyl carbonate, dimethyl sulfoxide (DMSO), and combinations thereof.

In step (a), the slurry may further comprise additives. The additives include at least one selected from the group consisting of polyacrylic acid, polyacrylate, polymethacrylic acid, polymethyl methacrylate, polyacryl amide, carboxymethyl cellulose, polyvinyl acetate, polymaleic acid, polyethylene glycol, polyvinyl resins, copolymers thereof, block copolymers comprising a block having high affinity for Si and a block having low affinity for Si, and combinations thereof.

In step (a), the first carbonization may be carried out under 1 to 20 bar at a temperature of 400 to 600° C. for 1 to 24 hours.

In step (b), the conductive material may include at least one selected from the group consisting of carbon black, acetylene black, Ketjen black, furnace black, carbon fiber, fullerene, copper, nickel, aluminum, silver, cobalt oxide, titanium oxide, polyphenylene derivatives, polythiophene, polyacene, polyacetylene, polypyrrole, polyaniline, and combinations thereof.

In step (b), the carbon source for fixing the conductive material may include at least one selected from the group consisting of natural or artificial graphite, soft carbon, hard carbon, pitch, calcined coke, graphene, carbon nanotube, and combinations thereof.

In step (b), the second dispersion medium may include at least one selected from the group consisting of N-methyl-2-pyrrolidone (NMP), tetrahydrofuran (THF), water, ethanol, methanol, cyclohexanol, cyclohexanone, methyl ethyl ketone, acetone, ethylene glycol, octyne, diethyl carbonate, dimethyl sulfoxide (DMSO), and combinations thereof.

In step (b), the second carbonization may be carried out under 1 to 20 bar at a temperature of 700 to 1400° C. for 1 to 24 hours.

In accordance with another aspect of the present invention, there is provided an anode for a secondary battery prepared by coating, on an anode current collector, anode slurry comprising the anode active material mentioned above, a binder, and a thickener.

In accordance with another aspect of the present invention, there is provided a secondary battery comprising the anode for a secondary battery mentioned above.

### Advantageous Effects

The anode active material according to the present invention provides enhanced conductivity and increased contact sites conductible between a carbon-silicon composite and an anode current collector, as well as more improved stability of the charge and discharge of a secondary battery.

Further, in the preparation of an anode for a secondary battery using the anode active material, additional conductive materials are not needed, whereby the problems of dust blown-out of the conductive material and the dispersibility between the anode active material and the conductive material can be avoided.

### DESCRIPTION OF DRAWINGS

The above and other aspects, embodiments and advantages of the present invention will become apparent and more readily appreciated from the following description of the embodiments, taken in conjunction with the accompanying drawing of which:

FIG. 1 is a schematic cross sectional view of an anode active material for a secondary battery in accordance with the present invention.

### BEST MODE

While exemplary embodiments of the present invention will now be illustrated and described in detail, it is to be understood that it is provided by way of example only, and that the invention is not to be construed as being limited thereto, but only by the scope of the following claims.

Anode Active Material for Secondary Battery

The present invention provides an anode active material for a secondary battery: comprising, a core layer comprising a carbon-silicon composite; and a shell layer comprising a conductive material and a carbonaceous material for fixing the conductive material, uniformly coated on a surface of the core layer.

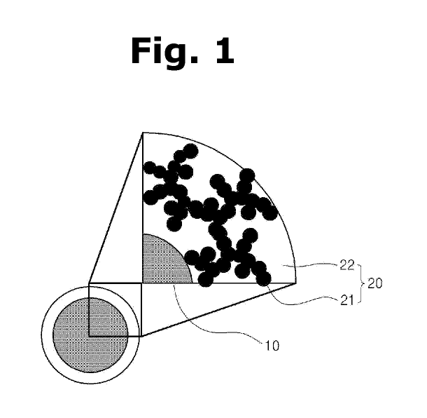

FIG. 1 is a schematic cross sectional view of an anode active material for a secondary battery in accordance with the present invention.

As depicted in FIG. 1, an anode active material for a secondary battery according to the present invention comprises a core layer (10) comprising a carbon-silicon composite; and a shell layer (20) comprising a conductive material (21) and a carbonaceous material (22) for fixing the conductive material, uniformly coated on a surface of the core layer.

The anode active material for a secondary battery according to the present invention comprises a core layer comprising a carbon-silicon composite, wherein the core layer may comprise silicon particles dispersed in a carbonaceous material.

In this way, since silicon is evenly dispersed throughout the core layer, the core layer, when applied to an anode active material, can effectively exhibit high capacity silicon properties, while improve the life characteristics of a secondary battery by mitigating the volume expansion problem during charge and discharge. Well-dispersed core layer can have a capacity greater than that having the same content of silicon. For example, the core layer may constitute at least about 80% of the theoretical capacity of silicon.

The core layer may be formed as spherical or spheroidal particles, the size of which may be in a range of 1 μm to 50 μm. The core layer having a particle size within the above range can improve the life characteristics of a secondary battery by mitigating the volume expansion problem during charge and discharge, while still effectively exhibit the high capacity silicon properties when applied to an anode active material for a secondary battery.

The core layer preferably may have a mass ratio of Si to C of 1:99 to 10:90. The core layer may contain a high content of silicon within the above range, while silicon particles are well dispersed in the core layer. Therefore, when silicon is applied to an anode active material, the volume expansion problem during the charge and discharge of a secondary battery can be improved.

The core layer preferably does not contain a conductive material. When the core layer comprises a conductive material, the structure of carbon during a first carbonization is unstable and does not exhibit conductivity. Thereby, the stability of the charge and discharge of a secondary battery may be rather poor.

The core layer may include at least one carbonaceous material selected from the group consisting of natural or artificial graphite, soft carbon, hard carbon, pitch carbide, calcined coke, graphene, carbon nanotube, polymeric carbide, and combinations thereof. In this case, it is desirable to use pitch carbide, obtainable by carbonizing pitch, which contains a first carbon Quinoline insoluble (QI) of 0.1 wt % to 20 wt %, and has a softening point (SP) in a range of 10° C. to 90° C.

The content of oxygen is very low since the core layer does not substantially contain an oxide which may slow down the performance of a secondary battery. Specifically, the core layer may have the content of oxygen in a range of 0% to 1% by weight. Moreover, the carbonaceous material contains substantially no other impurities and by-product compounds, and is mostly composed of carbon. Specifically, the content of carbon in the carbonaceous material may be in a range of 70% to 100% by weight.

The core layer, relative to the anode active material, is preferably from 60% to 99% by weight, and more preferably from 60% to 90% by weight. Here, when the core layer, relative to the anode active material, is less than the above range, the silicon content is less, and the initial charge capacity may be less, and when it exceeds the above range, since the shell layer contains a less conductive material, the electrical conductivity may not be sufficient.

Additionally, the anode active material for a secondary battery according to the present invention comprise a shell layer comprising a conductive material and a carbonaceous material for fixing the conductive material, wherein the shell layer is coated uniformly on a surface of the core layer to form some types of structures.

The shell layer may include a conductive material. Since the anode active material comprising a conductive material is highly conductive, the contact sites conductible between the silicon-carbon composite core layer and the anode current collector become increase, thereby further enhancing the stability of the charge and discharge of a secondary battery.

In this embodiment, the thickness of the shell layer may be in a range of 1 μm to 8 μm.

The shell layer, relative to the anode active material, is preferably from 1% to 40% by weight, and more preferably from 3% to 30% by weight. Here, when the shell layer, relative to the anode active material, is less than the above range, since the content of the conductive material such as carbon black is less, the electrical conductivity may not be sufficient, and when it exceeds the above range, since the core layer contains a less conductive material, the initial charge capacity may be less.

Preferably, the conductive material in the shell layer may include at least one selected from the group consisting of carbon black, acetylene black, Ketjen black, furnace black, carbon fiber, fullerene, copper, nickel, aluminum, silver, cobalt oxide, titanium oxide, polyphenylene derivatives, polythiophene, polyacene, polyacetylene, polypyrrole, polyaniline, and combinations thereof. More preferred is carbon black.

Carbon black is used as the conductive material, and corresponds to a fine carbon powder produced by the incomplete combustion of carbon-based compounds. Particle size of the carbon black may be in a range of 1 nm to 500 nm.

The carbonaceous material for fixing the conductive material in the core layer may include at least one selected from the group consisting of natural or artificial graphite, soft carbon, hard carbon, pitch, calcined coke, graphene, carbon nanotube, and combinations thereof. In this case, it is desirable to use pitch carbide, obtainable by carbonizing pitch, which contains a first carbon Quinoline insoluble (QI) of 0.1 wt % to 20 wt %, and has a softening point (SP) in a range of 10° C. to 90° C.

The carbonaceous material for fixing the conductive material is structured to be adapted to secure the conductive material in shape such that it can be homogeneously coated on a surface of the core layer. Thus, the existing conductive material does not exist in the anode active material for a secondary battery, but exist in an amorphous form, thereby capable of preventing the dust blown-out problem. In this case, it is desirable to use, as the carbonaceous material for fixing the conductive material, pitch carbide, obtainable by carbonizing pitch, which contains a carbon Quinoline insoluble (QI) of 0 wt % to 10 wt %, and a softening point (SP) in a range of 284° C.

In this embodiment, the carbonaceous material for fixing the conductive material is present in a range of 1 wt % to 20 wt % relative to the anode active material.

Preparation of Anode Active Material for Secondary Battery

The present invention provides a method for preparing an anode active material for a secondary battery: comprising, (a) mixing a carbon source with a slurry comprising silicon particles and a first dispersion medium, and then carrying out a first carbonization to form a core layer; and (b) mixing the core layer with a conductive material and a carbonaceous material for fixing the conductive material in a second dispersion medium, and then carrying out a second carbonization to form a shell layer.

The step (a) comprises the steps of mixing a carbon source with a slurry comprising silicon particles and a first dispersion medium, and then carrying out a first carbonization to form a core layer.

The carbon source is a starting material for forming a carbonaceous material, and may include at least one selected from the group consisting of natural or artificial graphite, soft carbon, hard carbon, pitch, calcined coke, graphene, carbon nanotube, polymer, and combinations thereof. In this case, it is desirable to use, as the carbonaceous material for fixing the conductive material, pitch carbide, which contains a carbon Quinoline insoluble (QI) of 0.1 wt % to 20 wt %, and a softening point (SP) in a range of 10° C. to 90° C.

Further, the slurry comprises silicon particles and a first dispersion medium, and the silicon particles in the slurry may satisfy 2 nm<D50<180 nm, where D50 denotes an average diameter of the silicon particles at 50% of cumulative particle size distribution. Thus, the silicon particles in the slurry may be selected from those having excellent dispersibility, or may be included in a first dispersion medium having good dispersibility for realizing excellent dispersion property, or may further comprise additives. Alternatively, it is possible to select efficient dispersion processes.

As a result, it can not only improve the dispersion of the silicon particles in the slurry, but also, unlike the silicon particles exposed to the air are easily oxidized, the oxidation of the silicon particles present in the slurry can be prevented. In this way, provided that the oxidation of the silicon particles can be prevented, even when the same amount of silicon particles are included in the anode active material, the capacity of the secondary battery can be more enhanced. As a result, the anode active material prepared using the slurry can implement the electrical characteristics of the secondary battery more excellent. Thus, the slurry can be used as an anode active material useful for a secondary battery.

Preferably, the first dispersion medium may include at least one selected from the group consisting of N-methyl-2-pyrrolidone (NMP), tetrahydrofuran (THF), water, ethanol, methanol, cyclohexanol, cyclohexanone, methyl ethyl ketone, acetone, ethylene glycol, octyne, diethyl carbonate, dimethyl sulfoxide (DMSO), and combinations thereof. The use of the first dispersion medium may assist the silicon particles such that the silicon particles are well dispersed in the slurry.

The slurry may further comprise additives. The additives include at least one selected from the group consisting of polyacrylic acid, polyacrylate, polymethacrylic acid, polymethyl methacrylate, polyacryl amide, carboxymethyl cellulose, polyvinyl acetate, polymaleic acid, polyethylene glycol, polyvinyl resins, copolymers thereof, block copolymers comprising a block having high affinity for Si and a block having low affinity for Si, and combinations thereof. The additives may be useful in suppressing the aggregation of the silicon particles.

Specifically, in the additives, the block copolymers together with the silicon particles in the slurry may form Si-block copolymer core-shell nanoparticles. The Si-block copolymer core-shell nanoparticles comprise a Si core; and a block copolymer shell, which comprises a block having high affinity for Si and a block having low affinity for Si, and forms a spherical micelle structure around the Si core.

The blocks having high affinity for Si are drawn towards a surface of the Si core by van der Waals interaction, and the like. The block having high affinity for Si includes, but not limited to, polyacrylic acid, polyacrylate, polymethacrylic acid, polymethyl methacrylate, polyacryl amide, carboxymethyl cellulose, polyvinyl acetate, or polymaleic acid.

The blocks having low affinity for Si are drawn towards the outside of the Si core by van der Waals interaction, and the like. The block having low affinity for Si includes, but not limited to, polystyrene, polyacrylonitrile, polyphenol, polyethylene glycol, polylauryl acrylate, or polyvinyl difluoride.

Most preferably, the block copolymer shell is a polyacrylic acid-polystyrene block copolymer shell. In this embodiment, preferably, the polyacrylic acid has a number average molecular weight (Mn) from about 100 g/mole to about 100,000 g/mole, and the polystyrene has a number-average molecular weight (Mn) from about 100 g/mole to about 100,000 g/mole.

The additives are present in an amount of about 0.1 parts to about 50 parts by weight based on 100 parts by weight of the silicon particles. Within this content range of the additives, the additives assist the slurry for anode active materials for a secondary battery in realizing uniform dispersion properties.

In order to realize the above-described uniform dispersion properties, the slurry may be subjected to various treatments, such as ultrasonication, fine milling, ball milling, fine milling, three-roll milling, stamp milling, eddy milling, homo mixing, planetary centrifugal mixing, homogenization, or vibration shaker treatment, and the like.

The slurry may be subjected to ultrasonication in order to achieve the above-described dispersion properties. The ultrasonication may be performed in a batch manner in which the overall slurry is subjected to ultrasonication or in a continuous circulation manner in which at least part of the slurry is continuously subjected to ultrasonication while circulating the slurry.

Since an apparatus for performing ultrasonication generally has a tip. Thus, the silicon particles are dispersed using ultrasonic energy generated from an end of the tip, and there is a limit in a contact area to which such ultrasonic energy is transferred. Therefore, if a large amount of the slurry is subjected to ultrasonication, an ultrasonication efficiency of the ultrasonication is improved by performing ultrasonication by the continuous circulation process, in which at least part of the slurry is continuously subjected to ultrasonication while circulating the slurry, rather than in the batch manner. That is, a greater amount of the slurry is subjected to ultrasonication through continuous circulation-type ultrasonication at the same electric power for the same period of time, in comparison with the case of the batch manner.

In some embodiments of process conditions, when the slurry is subjected to ultrasonication in the batch manner, about 1000 ml or less of the slurry is subjected to the ultrasonication for about 30 seconds to about 1 hour while supplying an electric power of about 100 W to about 500 W.

In some embodiments of process conditions, when the slurry is subjected to ultrasonication in the continuous circulation manner, about 3600 ml/hr of the slurry is subjected to the ultrasonication for about 30 seconds to about 1 hour while supplying an electric power of about 500 W.

In some embodiments of process conditions, ultrasonication is performed at, but not limited to, about 10 kHz to about 100 kHz.

As used herein, the term “carbonization process” refers to a process for removing inorganics by firing carbon source at high temperatures, while remaining residual carbon.

The first carbonization process may be carried out under 1 to 20 bar at a temperature of 400 to 600° C. for 1 to 24 hours. The first carbonization process may be carried out in one step or in multiple steps depending on the applications desired.

The carbonization yield in the first carbonization process is preferably, but not limited to, 40 to 80% by weight. Thus, by increasing the carbonization yield in the first carbonization process, the process becomes environmentally friendly since the generation of volatiles may be reduced and treated easily.

The step (b) comprises the steps of mixing the core layer with a conductive material and a carbonaceous material for fixing the conductive material in a second dispersion medium, and then carrying out a second carbonization to form a shell layer.

The second dispersion medium includes, but not limited to, at least one selected from the group consisting of N-methyl-2-pyrrolidone (NMP), tetrahydrofuran (THF), water, ethanol, methanol, cyclohexanol, cyclohexanone, methyl ethyl ketone, acetone, ethylene glycol, octyne, diethyl carbonate, dimethyl sulfoxide (DMSO), and combinations thereof.

The conductive material includes, but not limited to, at least one selected from the group consisting of carbon black, acetylene black, Ketjen black, furnace black, carbon fiber, fullerene, copper, nickel, aluminum, silver, cobalt oxide, titanium oxide, polyphenylene derivatives, polythiophene, polyacene, polyacetylene, polypyrrole, polyaniline, and combinations thereof. More preferably, carbon black is included, but not limited thereto.

The carbon source is a starting material for forming a carbonaceous material for fixing the conductive material, and may include at least one selected from the group consisting of natural or artificial graphite, soft carbon, hard carbon, pitch, calcined coke, graphene, carbon nanotube, and combinations thereof. It is desirable to use pitch carbide, as the carbonaceous material for fixing the conductive material, which contains a carbon Quinoline insoluble (QI) of 0 wt % to 10 wt %, and a softening point (SP) at a temperature of 284° C., but not limited thereto.

The second carbonization process may be carried out under 1 to 20 bar at a temperature of 700 to 1400° C. for 1 to 24 hours. The second carbonization process may be carried out in one step or in multiple steps depending on the applications desired.

The carbonization yield in the second carbonization process is preferably, but not limited to, 80% by weight or more, and more preferably 90% by weight or more. In other words, the carbonization yield in the second carbonization process is higher than that of the first carbonization process.

Anode for Secondary Battery

The present invention provides an anode for a secondary battery prepared by coating an anode slurry comprising the anode active material mentioned above, a binder, and a thickener on an anode current collector.

The anode for a secondary battery is formed by coating an anode slurry comprising the anode active material, a binder, and a thickener on an anode current collector, and drying and pressing the anode current collector.

In the conventional art, since in the case that the conventional silicon-carbon composite is used in an anode slurry, there is a problem that conductivity is deteriorated, when applied to the anode for a secondary battery, whereby the use of additional conductive materials is inevitable. In these embodiments, the additional conductive materials used may be at least one selected from the group consisting of carbon-based material, metal, metal oxides, and electric conductive polymers, and, specifically, may include carbon black, acetylene black, Ketjen black, furnace black, carbon fiber, fullerene, copper, nickel, aluminum, silver, cobalt oxide, titanium oxide, polyphenylene derivatives, polythiophene, polyacene, polyacetylene, polypyrrole, polyaniline, and combinations thereof.

Although the anode for a secondary battery according to the present invention may further comprise the conductive material mentioned above, the present invention is characterized by the pre-inclusion of carbon black into the anode slurry instead of the conductive material. Thus, it is desirable to omit the conductive material in order to prevent the dust blown-out, and the dispersibility between the anode active material and the conductive material.

The binder includes, but not limited to, styrene-butadiene rubber (SBR), carboxymethyl cellulose (CMC), poly(vinylidene fluoride-co-hexafluoropropylene) (PVDF-co-HFP), polyvinylidenefluoride, polyacrylonitrile, polymethylmethacrylate, etc. In some embodiments, the thickening agent intended to be used to control viscosity includes, but not limited to, carboxymethyl cellulose, hydroxymethyl cellulose, hydroxyethyl cellulose, hydroxypropyl cellulose, and the like.

The anode current collector includes, but not limited to, stainless steel, nickel, copper, titanium, or alloys thereof, and, most preferably, copper or copper alloy may be used.

Secondary Battery

The present invention provides a secondary battery comprising the anode for the secondary battery mentioned above.

The secondary battery is characterized by incorporating, as an anode active material, a carbon-silicon composite core layer, and a shell layer comprising carbon black, thereby producing an improved charge and discharge stability.

The secondary battery is prepared comprising an anode for the secondary battery, a cathode comprising a cathode active material, a separator, and an electrolyte.

In some embodiments, compounds capable of intercalating and de-intercalating lithium, such as LiMn₂O₄, LiCoO₂, LiNIO₂, LiFeO₂, may be used as materials for a cathode active material.

A separator is interposed between an anode and a cathode for insulating therebetween, and an olefinic porous film, such as polyethylene or polypropylene, may be used as the separator.

The electrolyte may include a lithium salt electrolyte with which a lithium salt is dissolved in at least one aprotic solvent, wherein the lithium salt includes, but not limited to, LiPF₆, LiBF4, LiSbF₆, LiAsF₆, LiClO₄, LiCF₃SO₃, Li(CF₃SO₂)₂N, LiC₄F₉SO₃, LiSbF₆, LiAlO₄, LiAlCl₄, LiN(CₓF₂ₓ+1SO₂)(C_{y}F_{2y}+1SO₂) (where, x and y denote natural number), LiCl, or LiI, and the at least one aprotic solvent includes, but not limited to, propylene carbonate, ethylene carbonate, butylene carbonate, benzonitrile, acetonitrile, tetrahydrofuran, 2-methyl tetrahydrofuran, y-butyrolactone, dioxolane, 4-methyl-dioxolane, N,N-dimethylformamide, dimethylacetamide, dimethyl sulfoxide, dioxane, 1,2-dimethoxyethane, sulfolane, dichloroethane, chlorobenzene, nitrobenzene, dimethyl carbonate, methyl ethyl carbonate, diethyl carbonate, methyl propyl carbonate, methyl isopropyl carbonate, ethyl propyl carbonate, dipropyl carbonate, diisopropyl carbonate, dibutyl carbonate, diethylene glycol, or dimethyl ether.

A plurality of secondary batteries can be connected with each other to provide a medium and large size battery module or battery pack. The medium and large size battery module or battery pack can be used as power source for any one of one or more of the medium or large size devices, such as electric vehicles including power tools, Electric Vehicle (EV), hybrid electric vehicles (HEV), and plug-in hybrid electric vehicles (PHEV); electric trucks; electric commercial vehicles; or a system for energy storage.

Now, some embodiments will be described in more detail with reference to some preferred examples. It should be noted, however, that these examples are provided for illustration only and are not to be construed in any way as limiting the present invention.

### EXAMPLES

### Example 1

Preparation of Anode Active Material for Secondary Battery

Polyacrylic acid-polyacrylonitrile block copolymer was synthesized through reversible addition-fragmentation chain transfer using polyacrylic acid and polyacrylonitrile. In this case, polyacrylic acid has a number average molecular weight (Mn) of 4090 g/mole, and polyacrylonitrile has a number average molecular weight (Mn) of 29370 g/mole. 0.25 g of Polyacrylic acid-polyacrylonitrile block copolymer was mixed into 44.75 g of N-methyl-2-pyrrolidone (NMP), the first dispersion medium. To the mixed solution, 5 g of silicon particles having the average particle size of 50 nm was dispersed to prepare slurry. In this case, the distribution characteristics of silicon was determined via dynamic light scattering method (instrument: ELS-Z2, Otsuka Electronics, Japan), and the result shows that D50=120 nm.

The first carbon source pitch (QI: 4 wt %, SP: 30° C.) 120 g was mixed and dispersed in 34 g of the slurry, followed by distillation to remove NMP. Then, the slurry was carbonized under 7 bar at 500° C. for 6 hours to form a core layer. The weight ratio of Si:C in the core layer was 4:96.

The core layer 8.5 g, carbon black 1 g, and pitch as the second carbon source (QI: 0 wt %, SP: 284° C.) 4.25 g were mixed in tetrahydrofuran (THF) 300 g, and the mixture was distilled to remove THF. Then, the mixture was further carbonized under 1 bar at 1100° C. for 1 hour to form a shell layer, and prepare an anode active material for a secondary battery.

Preparation of Anode for Secondary Battery

The anode active material, carboxylic methyl cellulose (CMC), and styrene-butadiene (SBR) were mixed in a weight ratio of 96:2:2 in water to prepare an anode slurry composition. The anode slurry composition was coated on a copper current collector and dried in an oven at 110° C. for 1 hour, followed by pressing to prepare an anode for a secondary battery.

Production of Secondary Battery

An anode for a secondary battery, a separator, an electrolyte (a mixed solvent of ethylene carbonate: dimethyl carbonate (1: 1 weight ratio), 1.0 M LiPF₆ added), and a lithium electrode were stacked in this order to prepare a coin cell type secondary battery.

### Comparative Example 1

An anode active material for a secondary battery, and an anode and a secondary battery using the anode active material were prepared in the same manner as Example 1, except that the core layer was used alone without forming the shell layer.

### Comparative Example 2

An anode active material for a secondary battery, and an anode and a secondary battery using the anode active material were prepared in the same manner as Example 1, except that the anode active material prepared in Comparative Example 1, carbon black (CB), carboxylic methyl cellulose (CMC), and styrene-butadiene (SBR) were mixed in a weight ratio of 95:1:2:2 in water to prepare an anode slurry composition.

### Comparative Example 3

An anode active material for a secondary battery, and an anode and a secondary battery using the anode active material were prepared in the same manner as Example 1, except that the anode active material prepared in Comparative Example 1, carbon black (CB), carboxylic methyl cellulose (CMC), and styrene-butadiene (SBR) were mixed in a weight ratio of 93:3:2:2 in water to prepare an anode slurry composition.

### Comparative Example 4

An anode active material for a secondary battery, and an anode and a secondary battery using the anode active material were prepared in the same manner as Example 1, except that a first carbon source pitch (QI: 4 wt %) 120 g and carbon black 4.2 g were mixed and dispersed in the slurry 34 g, and the resulting slurry was distilled to remove NMP; the slurry was carbonized under 7 bar at 500° C. for 6 hours to form the core layer; the core layer was further carbonized under 1 bar at 1100° C. for 1 hour; and then the core layer was used alone as the ande active material for a secondary battery without forming the shell layer.

### Experimental Example

Charge and discharge experiments were conducted under the following conditions for the secondary batteries prepared in Example 1 and Comparative Examples 1-4. Assuming 300 mA per unit weight as 1 C, charge condition was controlled at a constant current with 0.2 C to 0.01 V, and constant voltage with 0.01 V to 0.01 C, and discharge condition was determined at constant current with 0.2 C to 1.5 V.

The discharge capacity retention rates after 10 cycles were compared with the initial discharge capacity, and converted to a percentage (%). The results are shown in Table 1 below.

TABLE 1

| | | Com- | Com- | Com | Com- |
|---|---|---|---|---|---|
| | | parative | parative | parative | parative |
| | Example 1 | Example 1 | Example 2 | Example 3 | Example 4 |
| Discharge | 95 | 86 | 83 | 87 | 55 |
| capacity | | | | | |
| retention | | | | | |
| rate after 10 | | | | | |
| cycles (%) | | | | | |

As shown in Table 1, since the secondary battery prepared in Example 1 contains carbon black in the shell layer of the anode active material, the conductivity of the anode active material is increased, and the contact sites conductible between the carbon-silicon composite core layer and the anode current collector is increased, as well as the charge and discharge stability of the secondary battery can be further improved. In addition, it is found that since the secondary battery prepared in Example 1 is used without additional conductive materials, it is possible to prevent the dust blown-out problem due to the conductive material, and solve the dispersibility problem between the anode active material and the conductive material, while improving the stability of the charge and discharge of the secondary battery as compared with the secondary battery prepared in Comparative Example 2-3.

Meanwhile, it is found that since the secondary battery prepared in Comparative Example 4 contains carbon black in the core layer of the anode active material, there are problems that it makes unstable the structure of carbon during the first carbonization process, and does not exhibit the conductivity, whereby the stability of the charge and discharge of the secondary battery is significantly deteriorated.

While the invention has been described with respect to the above specific embodiments, it should be recognized that various modifications and changes may be made to the invention by those skilled in the art which also fall within the scope of the invention as defined by the appended claims.

What is claimed is:

1. An anode active material for a secondary battery: comprising,
a core layer comprising a carbon-silicon composite; and
a shell layer comprising a conductive material and a carbonaceous material for fixing the conductive material, uniformly coated on a surface of the core layer.

2. The anode active material of claim 1, wherein the core layer has a mass ratio of Si to C of 1:99 to 10:90.

3. The anode active material of claim 1, wherein the core layer comprises at least one carbonaceous material selected from the group consisting of natural or artificial graphite, soft carbon, hard carbon, pitch carbide, calcined coke, graphene, carbon nanotube, polymeric carbide, and combinations thereof.

4. The anode active material of claim 1, wherein the core layer is in a range of 60% to 99% by weight, relative to the anode active material.

5. The anode active material of claim 1, wherein the conductive material in the shell layer comprises at least one selected from the group consisting of carbon black, acetylene black, Ketjen black, furnace black, carbon fiber, fullerene, copper, nickel, aluminum, silver, cobalt oxide, titanium oxide, polyphenylene derivatives, polythiophene, polyacene, polyacetylene, polypyrrole, polyaniline, and combinations thereof.

6. The anode active material of claim 1, wherein the conductive material in the shell layer is in a range of 1% to 40% by weight, relative to the anode active material.

7. The anode active material of claim 1, wherein the carbonaceous material for fixing the conductive material in the shell layer comprises at least one selected from the group consisting of natural or artificial graphite, soft carbon, hard carbon, pitch carbide, calcined coke, graphene, carbon nanotube, and combinations thereof.

8. A method for preparing an anode active material for a secondary battery: comprising,
(a) mixing a carbon source with a slurry comprising silicon particles and a first dispersion medium, and then carrying out a first carbonization to form a core layer; and
(b) mixing the core layer with a conductive material and a carbonaceous material for fixing the conductive material in a second dispersion medium, and then carrying out a second carbonization to form a shell layer.

9. The method of claim 8, wherein, in step (a), the carbon source comprises at least one selected from the group consisting of natural or artificial graphite, soft carbon, hard carbon, pitch, calcined coke, graphene, carbon nanotube, polymer, and combinations thereof.

10. The method of claim 8, wherein, in step (a), the silicon particles in the slurry satisfies 2 nm<D50<180 nm, where D50 denotes an average diameter of the silicon particles at 50% of cumulative particle size distribution.

11. The method of claim 8, wherein, in step (a), the first dispersion medium comprises at least one selected from the group consisting of N-methyl-2-pyrrolidone (NMP), tetrahydrofuran (THF), water, ethanol, methanol, cyclohexanol, cyclohexanone, methyl ethyl ketone, acetone, ethylene glycol, octyne, diethyl carbonate, dimethyl sulfoxide (DMSO), and combinations thereof.

12. The method of claim 8, wherein, in step (a), the slurry further comprises additives, the additives including at least one selected from the group consisting of polyacrylic acid, polyacrylate, polymethacrylic acid, polymethyl methacrylate, polyacryl amide, carboxymethyl cellulose, polyvinyl acetate, polymaleic acid, polyethylene glycol, polyvinyl resins, copolymers thereof, block copolymers comprising a block having high affinity for Si and a block having low affinity for Si, and combinations thereof.

13. The method of claim 8, wherein, in step (a), the first carbonization is carried out under 1 to 20 bar at a temperature of 400 to 600° C. for 1 to 24 hours.

14. The method of claim 8, wherein, in step (b), the conductive material comprises at least one selected from the group consisting of carbon black, acetylene black, Ketjen black, furnace black, carbon fiber, fullerene, copper, nickel, aluminum, silver, cobalt oxide, titanium oxide, polyphenylene derivatives, polythiophene, polyacene, polyacetylene, polypyrrole, polyaniline, and combinations thereof.

15. The method of claim 8, wherein, in step (b), the carbon source for fixing the conductive material comprises at least one selected from the group consisting of natural or artificial graphite, soft carbon, hard carbon, pitch, calcined coke, graphene, carbon nanotube, and combinations thereof.

16. The method of claim 8, wherein, in step (b), the second dispersion medium comprises at least one selected from the group consisting of N-methyl-2-pyrrolidone (NMP), tetrahydrofuran (THF), water, ethanol, methanol, cyclohexanol, cyclohexanone, methyl ethyl ketone, acetone, ethylene glycol, octyne, diethyl carbonate, dimethyl sulfoxide (DMSO), and combinations thereof.

17. The method of claim 8, wherein, in step (b), the second carbonization is carried out under 1 to 20 bar at a temperature of 700 to 1400° C. for 1 to 24 hours.

18. An anode for a secondary battery prepared by coating an anode slurry comprising the anode active material of claim 1, a binder, and a thickener, on an anode current collector.

19. A secondary battery comprising the anode of claim 18.
